(19) United States
(12) Patent Application Publication
(10) Pub. No.: US 2002/0023862 A1
(43) Pub. Date: Feb. 28, 2002

(54) Slurry weir system

(76) Inventors: Michael W. Linwood, Tiburon, CA (US); Sheena B. Hebbar, Foster City, CA (US); William J. O'Rourke, Clayton, CA (US); Kenneth R. Coyne, Lafayette, CA (US)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/880,082

(22) Filed: Jun. 14, 2001

Related U.S. Application Data
(60) Provisional application No. 60/211,531, filed on Jun. 15, 2000.

(51) Int. Cl. B01D 21/30

(52) U.S. Cl. 210/97

(57) ABSTRACT

A system for separating a slurry flow includes a distributor having an inlet for receiving the slurry flow and at least two outlets for redirecting the slurry flow to respective designations. A flow sensor is coupled to the distributor for monitoring a characteristic of the slurry flow. A flow controller is coupled to the flow sensor for monitoring a delivery of the slurry flow from at least one of the outlets. Preferably, the respective quantity of the slurry flow redirected by the controlled outlet is monitored.

### BACKGROUND OF THE INVENTION

This invention relates to the processing of ore. Specifically, it relates to the milling of ore in a mineral separation process.

In a typical arrangement, coarse ore is delivered to a primary crusher and then to a SAG (Semi-autogenous grinding) mill for further size reduction. The ore is further processed through ball mills and the finer particles are then passed to flotation separators to be divided into their mineral components.

In a large operation, it is common to divide the slurry coming from the SAG mill and ball mills into two or more streams to be delivered to an equivalent number of cyclones and ball mills. For maximum efficiency the separated streams should be of equal volume. This invention is concerned with the adjustable splitting of large volumes of abrasive slurry containing coarse solid particles.

As described, the invention is specifically associated with a SAG mill/ball mill application. While conceived for this application, it is by no means limited to it, and has potential applications wherever controlled splitting of slurry flows is desired, and especially with coarse abrasive particles.

### SUMMARY OF THE INVENTION

According to one aspect of the invention, there is a distribution box for receiving an ore slurry with at least two separated outlets and adjustable flow control means for controlling flow through at least one of the outlets. Preferably the flows are sensed through a combination of magnetic flow measurements, density measurements of the flows, and ball mill power draw measurements. The flow control means is adjustable in response to the sensing mean. Preferably the flow control means is adjustable in response to the sensing mean. Preferably the flow control means comprises an adjustable height weir.

In a preferred embodiment, the distribution box has three separated outlets, one of which has a fixed weir and the others of which have adjustable height weirs.

### BRIEF DESCRIPTION OF THE DRAWINGS

A preferred embodiment of the invention is illustrated in the accompanying drawings in which:

FIG. 1 is a schematic illustration of a part of an ore processing plant;

FIG. 2 is a perspective view of the distribution box in FIG. 1;

FIG. 3 is a plan view of the distribution box of FIG. 2; and

FIGS. 4 and 5 are side views showing a weir of this invention.

### DESCRIPTION OF THE PREFERRED EMBODIMENT

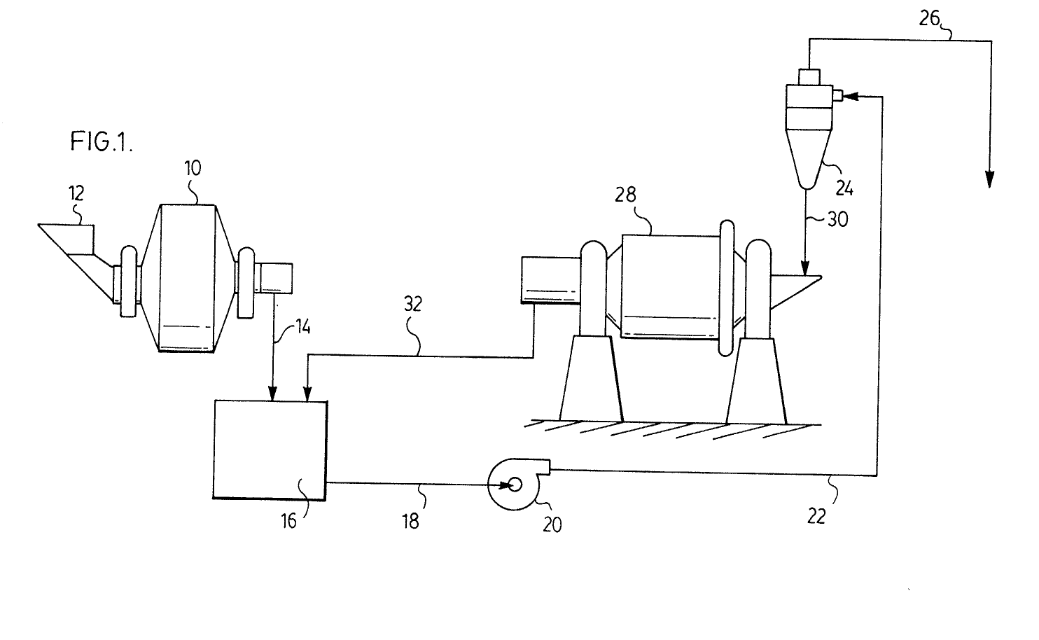

Referring to FIG. 1, there is a SAG mill 10 which receives a crushed ore at its inlet 12 from a primary crushing system, not illustrated but of conventional type. The output of the SAG mill is delivered through line 14 to a distribution box 16. In a manner described hereinafter, the distribution box splits the slurry between three outlets, each connected to a line (only one of which is represented in FIG. 1 at 18).

The lines 18 lead to three centrifugal pumps 20 (again, only one is shown in FIG. 1), the output lines 22 from the pump lead to three cyclone separators one of which is illustrated at 24. Output lines 26 convey finely ground mineral particles from the cyclone separators to flotation separating equipment. Coarser particles are delivered to a 28 (one of 3 illustrated) through return lines 30 and from the ball mill to the distribution box 16 through lines 32.

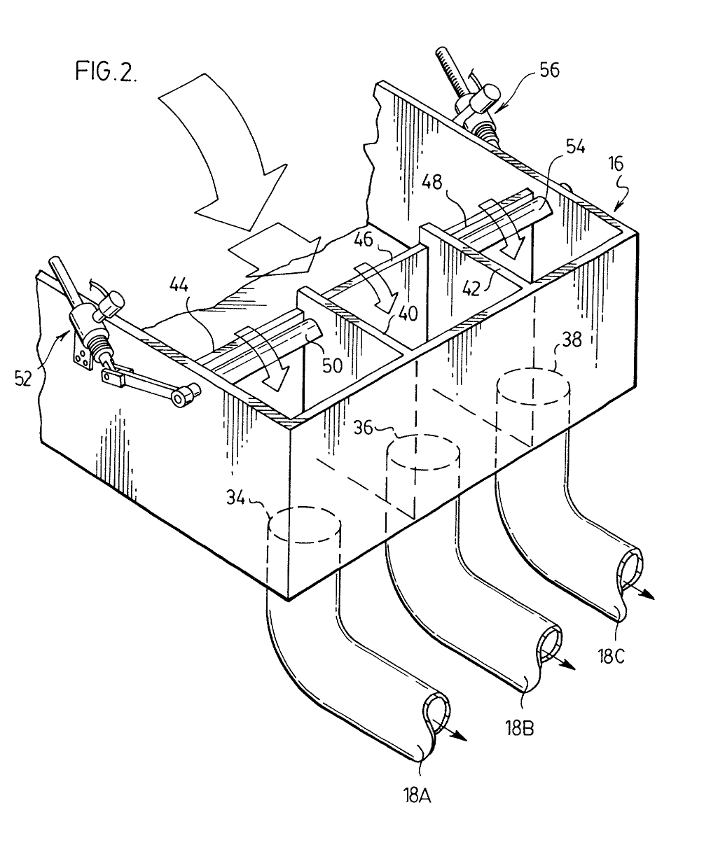

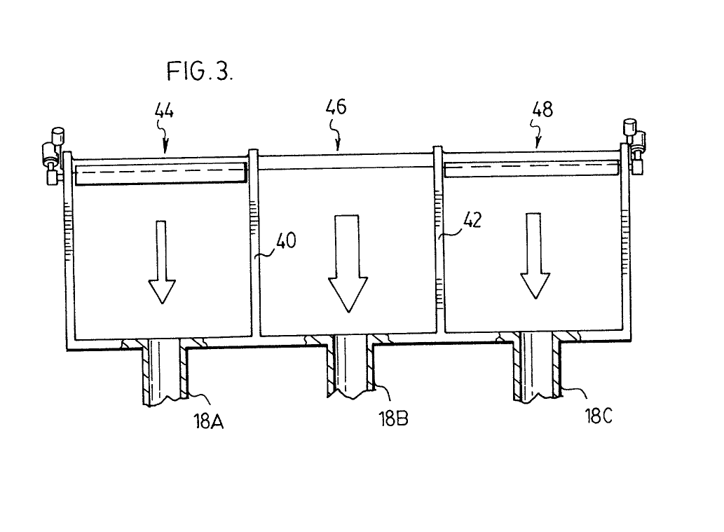

The distribution box 16 is illustrated in FIGS. 2 and 3. It is essentially a box-shaped structure with three outlets 34, 36 and 38 leading to lines 18A, 18B and 18C respectively. The outlets are separated by walls 40 and 42 which, together with weirs 44, 46 and 48, form three compartments each delivering to one of the outlets 34, 36 or 38. The compartments receive slurry over the weirs.

The weir 46 is of fixed height. Weir 44 has a pivoted plate 50 the position of which is controlled by a mechanism 52. By adjusting the angular position of the plate 50, the height of the weir is changed. Weir 48 has a similar plate 54 and control mechanism 56. To protect the weirs from the abrasive effects of slurry, the surfaces of the weir are covered with heavy rubber or with bonded ceramic tile. Weir nap air vents are provided to relieve air pressures underneath the weir and thus prevent the surging of flow across the weirs.

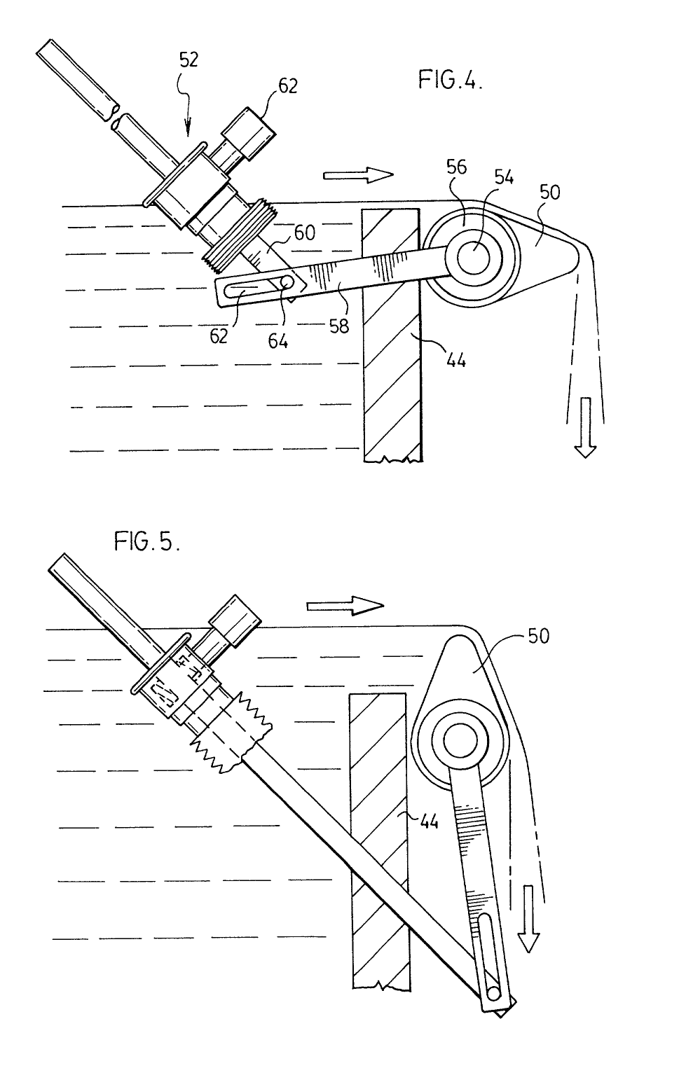

The height-adjustable weirs and their control mechanisms are illustrated in greater detail in FIGS. 4, 5 and 6. The plates 50 are of triangular section and have bearing hubs 56 mounted on pivots 54. Each bearing is fitted with a high pressure water flush to clear the bearing of accumulated solids, and the outboard bearings (outboard of weirs 44 and 48) are also fitted with packing seals mounted in flanged housings. A control arm 58 is secured to hub 56.

In operation, the delivery of slurry from the adjustable weirs is monitored and the mechanisms 52 and 56 are activated in response to the aforementioned measurements of flow, density and power draw to appropriately raise or lower the heights of weirs 44 and 48 to control the flow over all three weirs.

The methods of sensing volumetric splitting and controlling the weir actuators are known and several techniques will be available to those skilled in the art.

What is claimed is:

1. A system for separating a slurry flow, the system comprising:
a) a distributor including an inlet for receiving the slurry flow and at least two outlets for redirecting the slurry flow to respective designations;
b) a flow sensor coupled to the distributor for monitoring a characteristic of the slurry flow; and
c) a flow controller coupled to the flow sensor for monitoring a delivery of the slurry flow from at least one of the outlets;
wherein the respective quantity of the slurry flow redirected by the controlled outlet is monitored.
